(19) United States
(12) Patent Application Publication
(10) Pub. No.: US 2015/0030284 A1
(43) Pub. Date: Jan. 29, 2015

(54) ROTARY COUPLING FOR TRANSMITTING OPTICAL SIGNALS ALONG AT LEAST TWO SEPARATE OPTICAL TRANSMISSION CHANNELS

(71) Applicant: Spinner GmbH, Westerham (DE)

(72) Inventors: Andreas DOLESCHEL, Gross Helfendorf (DE); Gerhard FRIEDSAM, Feldkirchen (DE)

(21) Appl. No.: 14/337,410

(22) Filed: Jul. 22, 2014

(30) Foreign Application Priority Data
Jul. 23, 2013 (DE) 10 2013 012 236.8

(51) Int. Cl. G02B 6/36; G02B 6/26

(52) U.S. Cl. CPC G02B 6/3604; G02B 6/262
USPC 385/26

(57) ABSTRACT

The invention is characterized by optical deflector units comprising at least two optical reflectors, which are in case rigidly connected to one another indirectly or directly via a retaining element, and in that a first of the two retaining elements is indirectly or directly in engagement with the first coupling component via a mechanical gear unit providing a rotatable operative connection.

### CROSS REFERENCE TO RELATED APPLICATION

Reference is made to German Application Serial No. 10 2013 012 236.8, filed Jul. 23, 2013, which application is incorporated herein by reference in its entirety.

### BACKGROUND OF THE INVENTION

1. Field of the Invention

The invention relates to a rotary coupling for transmitting optical signals along at least two separate optical transmission channels, having two coupling components that are mounted rotatably relative to one another about a common rotational axis.

2. Description of the Prior Art

Optical rotary couplings or optical rotary transmitters are used for transmitting optical signals along at least one optical transmission channel between two components or modules, which are mounted to be rotatable about a common rotational axis. For an interruption-free optical signal transmission along an optical transmission channel, the ends of two optical waveguides are arranged in two coupling components that are mounted to rotate relative to one another about a common axis, to ensure with or without the interposition of optical elements, that light signals emerging from one optical waveguide end can also be coupled as losslessly as possible into the opposite optical waveguide end during the rotation of both coupling components with respect to one another and vice versa.

The structure of an optical rotary coupling for transmitting optical signals along a single optical transmission channel is described in EP 0 57 794. This rotary coupling has two coupling components, which are mounted to be rotatable relative to one another and are essentially rotational symmetrically and along a common rotational axis. Each component has recesses longitudinally to the rotational axis for accommodating an optical waveguide, so that the end faces of both optical waveguides are arranged opposite one another coaxially along the rotational axis. To enlarge the apertures of both optical waveguide ends, cylindrically constructed lens bodies are placed at the end on both optical waveguide ends in each case. The lens bodies together enclose a small gap, by which the optical signals are losslessly transmitted in spite of the rotation of both coupling components relative to one another.

In contrast, transmitting more than one optical transmission channel with the aid of an optical rotary coupling, increases the complexity of the rotary coupling in relation of the number of optical transmission channels to be transmitted.

An optical rotary coupling for transmitting two optical transmission channels is disclosed in U.S. Pat. No. 7,724,996 B2, which comprises two coupling components that are mounted rotatably about a rotational axis, which together enclose a cylindrical cavity and at end faces, axially defining the cavity, apertures of two optical waveguide ends are located. In each case, one of the two apertures is arranged centrally with respect to the rotational axis and the other is arranged radially spaced from the rotational axis in each case. The latter is additionally provided with a focussing optic, which causes the light emerging from the aperture to be imaged onto the aperture of the opposite coupling component, which is arranged centrally with respect to the rotational axis. The known optical rotary coupling can only be used unidirectionally with a predetermined optical signal transmission direction.

U.S. Pat. No. 7,515,782 B2 discloses an optical rotary coupling for transmitting two optical transmission channels, with one optical transmission channel is being arranged coaxially to the rotational axis and thus is invariantly rotational. The end faces of two optical waveguide ends are fixed spaced apart with respect to one another along the rotational axis in two coupling components mounted rotatably relative to one another. A second optical transmission channel is defined by two further optical waveguides, which are fastened in the individual coupling components parallel and spaced from the rotational axis and with apertures being located opposite one another at the longitudinal end of the rotational axis. Optical reflectors arranged between both apertures ensure that the light path of the second optical transmission channel is superposed with the rotation-invariant light path of the first optical transmission channel. To this end, suitably chosen semi-permeable reflectors, which are arranged along the rotational axis and thus along the first optical transmission channel, are provided.

The rotation invariance of an optical transmission channel arranged rotationally symmetrically about the rotational axis is also beneficial for the optical rotary coupling described in U.S. Pat. No. 4,842,355. To obtain a first optical transmission channel, one optical waveguide is arranged longitudinally relative to the rotational axis within two coupling components. Both optical waveguides join optical imaging elements at the ends at the apertures to form a hollow cylindrical light path between the two rotatably arranged coupling components, which is symmetrical to the rotational axis, to provide the rotation invariance. To provide the second optical transmission channel, the apertures of two additional optical waveguides are disposed between the optical imaging elements, which lie opposite one another at the end, so that the apertures assigned to the second optical transmission channel also disposed centrically relative to the rotational axis, as a result of which, a rotation-invariant optical signal transmission is also possible along the second optical transmission channel.

An optical rotary coupling constructed to have multiple channels, particularly for transmitting optical signals of at least two optical transmission channels K1, K2 is disclosed in U.S. Pat. No. 4,725,116, which provides two coupling components 1, 2, which are mounted rotatably relatively to one another about a common rotational axis D shown in FIG. 2, coupling components at least at an end of two optical waveguides L1, L2, L3, L4 and the assigned apertures A1, A2, A3, A4. Optical signals can be indirectly or directly coupled in and/or out, are in each case arranged facing the other coupling component 1, 2. Wherein, for each coupling component 1, 2, a first aperture A1, A3 is added centrally to the rotational axis D and a second aperture A2, A4 is added which is spaced radially from the rotational axis D. At least one first and second optical deflector unit 3, 4 are arranged between the apertures A1, A2, A3, A4 of both coupling components 1, 2. The apertures are arranged facing one another axially to the rotational axis D, so that the optical deflectors in each case deflect one of the two optical transmission channels K1, K2 so that a first optical transmission channel K1 runs through the first aperture A1 of the first coupling component 1 and also through the second aperture A4 of the second coupling component 2 and a second optical transmission channel K2 runs through the second aperture A2 of the first coupling component 1 and also through the first aperture A3 of the second coupling component 2. The first optical transmission unit 3 is connected to the second coupling component 2 and the second optical deflector unit 4 is rotationally fixedly connected to the first coupling component 1, with the first optical deflector unit 3 being arranged along the rotational axis D between the second optical deflector unit 4 and the first coupling component 1, which is rotatably in operative connection with the same.

For both optical deflector units 3, 4, it is desired to losslessly divert one of the two optical transmission channels K1, K2, preferably by way of reflection, and at the same time to allow through the light path of the respective other optical transmission channel as losslessly as possible. A fastening tube is mechanically connected to the second coupling component 2 and is arranged coaxially relative to the rotational axis D, and to which the first optical deflector unit 3 is securely joined, which is used for the purpose of providing a rotationally fixed connection between the first optical deflector unit 3 and the second coupling component 2. The tube wall is a material that is transparent for the second optical transmission channel K2. The second optical deflector unit 4 has two reflector elements deflecting the second optical transmission channel K2 from the second aperture A2 of the first coupling component to the first aperture A3 of the second coupling component or vice versa, to which one reflector element is attached radially outside and the other is attached radially inside the transparently constructed tube. A magnetic coupling is used as a rotatable coupling of the reflector element attached within the fastening tube to the rotational movement about the rotational axis D of the first coupling element 1. Due to the magnetic coupling, at least the deflection of the light path along the second optical transmission channel K2 is subject to optical losses owing to changes in position of both magnetically coupled reflector elements of the second optical deflector unit with respect to one another that occur, particularly in the form of vibrations that occur.

A catheter for optical investigations is disclosed in WO 2002/096484 A2. A light ray is conducted from a position under investigation back to a detector. The light ray is in this case guided via a coupler, which has a part, which is rotatable about an axis, with transparent ends, on which one prism is arranged such that light rays arriving radially spaced from the axis are deflected by the prisms onto the axis.

U.S. Pat. No. 5,271,076 discloses a planetary gear for enabling a rotational relative movement between a prism rotor and a rotating retaining element for optical fibres and lenses.

### SUMMARY OF THE INVENTION

Starting from A known optical rotary coupling for transmitting optical signals along at least two separate optical transmission channels as disclosed in U.S. Pat. No. 4,725,116, it is necessary to take measures, so that transmission quality is improved and in particular lossy optical attenuation phenomena owing to changes in position that occur among the reflector elements involved in the light deflection should be minimized. Furthermore, the optical and mechanical structure of such a rotary coupling should be simplified, as a result of which the production costs are lowered without impairment of quality.

The rotary coupling according to the invention begins with an optical rotary coupling, which is known per se, as is disclosed in U.S. Pat. No. 4,725,116.

To transmit optical signals along at least two separate optical transmission channels, two coupling components are mounted rotatably relative to one another about a common axis. In both coupling components, at least two recesses for accommodating the ends of two optical waveguides are provided, to which one aperture in each coupling component is assigned for coupling optical light signals in and out. A first aperture is in each case located centrally with respect to the rotational axis and a second aperture is added radially spaced from the rotational axis. At least one first and second optical deflector unit, which are able to deflect one of the two optical transmission channels between the apertures of both coupling elements, is located between the first and second apertures of both coupling components and are orientated to face each other longitudinally relative to the rotational axis. Thus, a further first deflector unit transmits the first optical transmission channel from the first aperture of the first coupling component to the second aperture of the second coupling component. the second optical deflector unit transmits the second optical transmission channel from the second aperture of the first coupling component into the first aperture of the second coupling component. Preferably, both optical deflector units are constructed so that the optical transmission properties along both optical transmission channels are bidirectional. For interruption-free optical signal transmission, the first optical deflector unit having the second coupling component and the second optical deflector unit having the first coupling component, are rotatably in operative connection about the rotational axis. The first optical deflector unit is arranged along the rotational axis between the second optical deflector unit and the first coupling component, which is rotatably in operative connection with the same.

According to the invention, the optical rotary coupling includes each optical deflector unit comprises at least two optical reflectors, which are rigidly connected to one another indirectly or directly via a retaining element, while forming a mechanically rigid joint. In this manner, it is ensured that changes in position or relative vibrations between the optical reflectors, which are rigidly connected to one another, of each optical deflector unit are minimized or even excluded completely. On the other hand, the rotary transmission between at least one coupling component to the optical deflector unit that is rotatably in operative connection about the rotational axis is provided by a mechanical gear unit, which is indirectly or directly in operative connection with a coupling component on the one hand and with the retaining element of the optical deflector unit, which rigidly connects the at least two optical reflectors to one another, on the other hand.

In a preferred embodiment of the optical rotary coupling, a first deflector unit, which is not in engagement with the mechanical gear unit, is mechanically rigidly and rotationally fixedly connected indirectly or directly to the second coupling component. The first deflector unit is arranged between the first coupling component and the second optical deflector unit and is decoupled from rotational movement of the first coupling component completely. The first optical deflector unit is securely connected to the second coupling component via a sleeve-shaped section. The sleeve-shaped section radially defines an inner cavity, which has a an end of open construction at least facing the first coupling component, through which the second optical deflector unit protrudes into the cavity of the sleeve-shaped section at least to some extent. The sleeve-shaped section further has at least one opening or recess along the axial extent thereof, which is locally defined in the circumferential direction of the sleeve-shaped section. A radial engagement of the gear unit arranged radially outside the sleeve-shaped section occurs with the first optical deflector unit enveloped by the sleeve-shaped section at least to some extent.

In a further preferred embodiment, the gear unit is constructed as a spur gear, which is arranged eccentrically to the rotational axis within the rotary coupling and is arranged radially relative to the rotational axis outside of the substantially rotationally symmetrically constructed first coupling component. The gear unit is comprised of individual components, as shown and is arranged outside the sleeve-shaped section of the second coupling component. In this case, a spur wheel of two axially spaced spur wheels of the spur gear engages a toothing structure assigned to the first coupling component and a second spur wheel engages a toothing structure provided on the second optical deflector unit. The gear unit bridges at least one region of the sleeve-shaped section lying axially between the first coupling component and the second optical deflector unit.

In a second preferred embodiment, the gear unit is constructed as a ring gear, having an annular or hollow cylindrical gear body with two axially spaced gear toothings applied on the ring inner side of the gear body. Radially externally, the ring gear at least comprises regions of the first coupling component, the sleeve-shaped section rigidly connected to the second coupling component and also the second optical deflector unit. The cylindrical axis assigned to the ring gear is arranged to be co-parallel with and spaced from the rotational axis. Due to the eccentric position of the ring gear relative to the rotational axis, the gear toothings only engage circumferential segments of the toothing structure assigned to the first coupling component and also the toothing structure provided on the second optical deflector unit. When the construction of the gear unit is ring gear, the gear unit bridges at least one region of the sleeve-shaped section lying axially between the first coupling component and the second optical deflector unit. Further details of the construction are apparent from the description of the gear unit with reference to the drawings.

For the purpose of transmission of optical signals that are as lossless as possible by the optical rotary coupling, the optical deflector units required for the deflection of the optical transmission channels are constructed so that the at least two optical reflectors per optical deflector unit are rigidly connected via a retaining element preferably constructed in a sleeve-shaped section. The rigid connection ensures not only to prevent possible changes in position between the optical reflectors of an optical deflector unit and the retaining element rigidly connecting the optical reflectors to one another ensures a highly precise joint and alignment of the at least two optical reflectors in the retaining element.

The retaining elements of the optical deflector units are advantageously constructed as longitudinal hollow bodies having a hollow channel passing longitudinally completely through the hollow body. The hollow channel longitudinal axis coincides with the rotational axis of the rotary coupling. Defined joining points or joining surfaces for attaching transparent support elements are provided on the retaining element which is constructed as a hollow body, on which support elements, the optical reflectors are applied for example in the form of a highly reflective coating, for example a gold coating. The support elements can be constructed as transparent glass plates, which are securely attached on or inside the hollow body. Instead of or in combination with the provision of highly reflective coatings on the support element, deflecting prisms, which can be attached on a common flat surface of the support element, also possible.

Particularly for use of deflection prisms, a preferred embodiment for the construction of each of the first and second optical deflector unit has at least one support element, which is transparent for at least one optical transmission channel and on which the at least two optical reflectors are attached which are deflection prisms for deflecting a transmission channel. One of the two reflectors is attached centrally with respect to the rotational axis and the other of the two reflectors is attached radially spaced from the rotational axis to provide a surface area with respect to the surface of the support element supporting the deflection prisms so that, during rotation about the rotational axis, the eccentrically attached deflection prism slips over an annular surface, which is not cut by the light path of the optical transmission channel and merely penetrates losslessly the support element.

A further preferred embodiment for the optical rotary coupling includes at least two support elements in each case for the construction of each of the first and second optical deflector units. The support elements are transparent for at least one optical transmission channel and are fastened spaced apart from one another on the retaining element longitudinally relative to the rotational axis. One of the two reflectors is attached centrally with respect to the rotational axis on one of the at least two support elements. The other of the two reflectors is attached on the other of the at least two support elements radially spaced from the rotational axis. The reflector attached radially spaced from the rotational axis slips over an annular surface during rotation about the rotational axis. The annular surface does not cut the other optical transmission channel that penetrates both transparent support elements. In this case, the reflectors are attached separately on the support elements are each constructed as a highly reflective, locally delimited coating.

A further preferred embodiment of the optical rotary coupling provides one support element for each of the first and second optical deflector units. The support element is transparent for at least one optical transmission channel and carries the reflector arranged centrally with respect to the rotational axis. As is also the case for all previously explained transparent support elements, a plane-parallel pane of glass or a glass platelet is suitable for this. The transparent plate or platelet element is constructed as a wall as this as possible, in order to keep a geometric ray offset as negligibly small as possible in the case of a ray course orientated obliquely to the glass pane surface. The glass pane support element is preferably arranged within the hollow channel and is enveloped along the entire circumferential edge by the retaining element constructed as a hollow body. By contrast, the other reflector is attached to the retaining element itself indirectly or directly with a radial spacing from the rotational axis. The radial spacing of the first aperture from the rotational axis is preferably larger than the radial spacing from the rotational axis of the second aperture of the first and second coupling components.

To deflect the light path of both optical transmission channels, the optical reflectors of the first and second optical deflector units are aligned, subject to the law of optical reflection, with respect to one another, so that the desired ray deflection between the first and second apertures of the first and second coupling components takes place. To this end, the at least one support element having the optical reflectors located thereon are attached on the retaining element in a suitable manner relative to the rotational axis or inclined to a hollow channel axis that can be assigned to the retaining element. Thus, a planar surface supporting the at least one optical reflector can be assigned to the at least one transparent support element, which planar surface encloses an angle α=90±45° with the longitudinal direction or the hollow channel axis of the hollow channel and thereby penetrates the hollow channel in the cross section thereof at least to some extent. That is, the transparent support element does not necessarily have to protrude above the entire cross section of the hollow channel of the support element.

### BRIEF DESCRIPTION OF THE DRAWINGS

The invention is described by way of example in the following without limitation thereof by exemplary embodiments with reference to the drawings. In the figures:

FIG. 1a shows a longitudinal section illustration through a first coupling embodiment according to the invention;

FIG. 1b shows a longitudinal section illustration through a second coupling embodiment according to the invention;

FIG. 1c shows an alternative exemplary embodiment for implementing of the first and second optical deflector units; and

FIG. 2 shows a schematic illustration for building an optical rotary coupling according to the prior art.

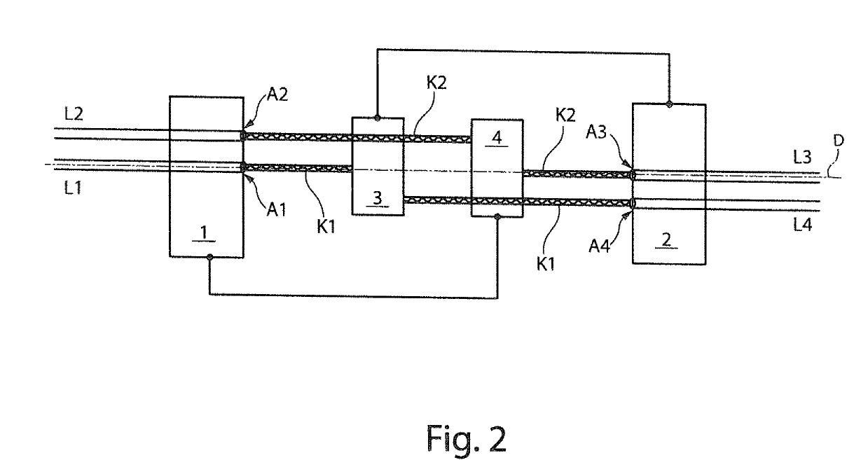

### DETAILED DESCRIPTION OF THE INVENTION

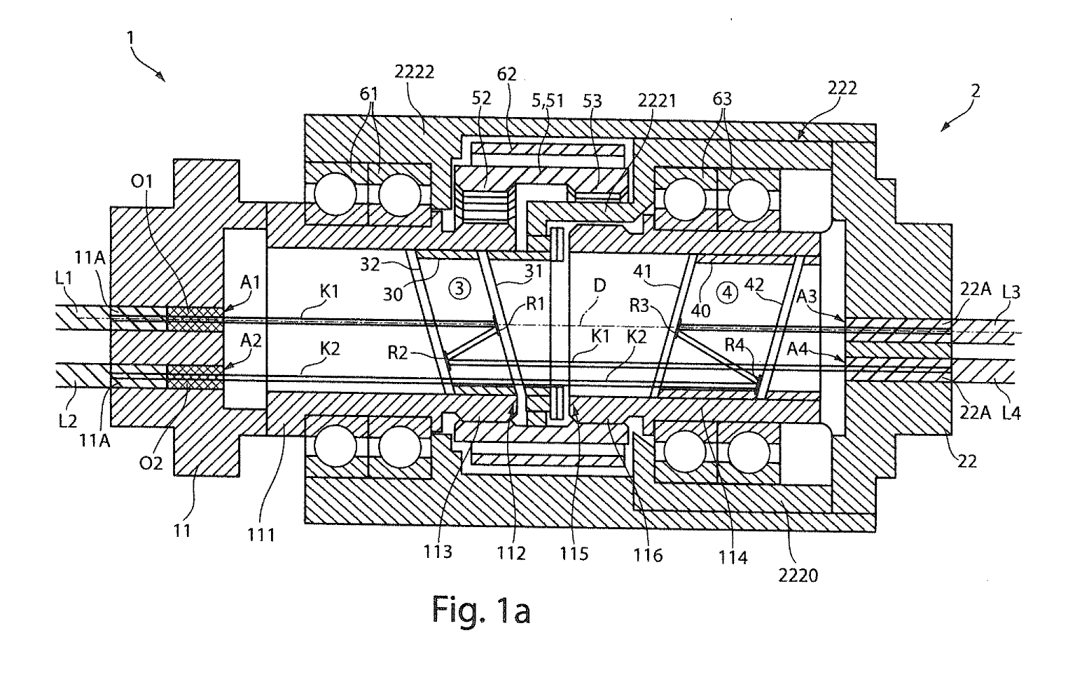

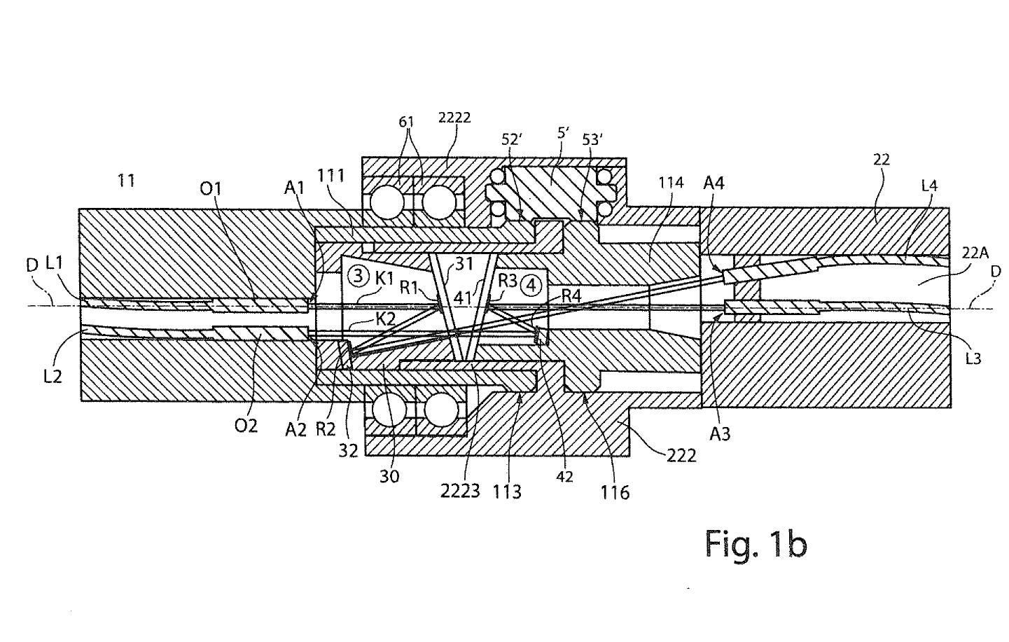

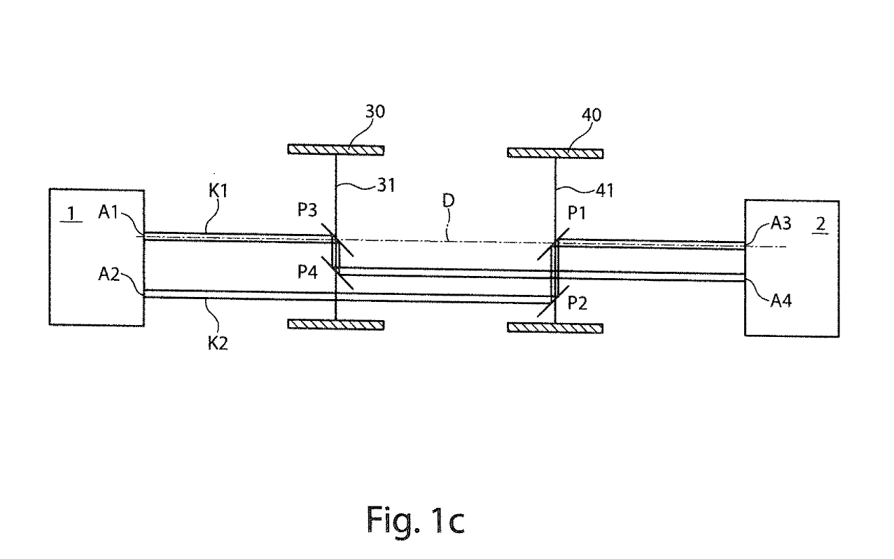

FIG. 1a shows a longitudinal section through an optical rotary coupling for transmitting optical signals along at least two separate optical transmission channels K1, K2, having two coupling components 1, 2 that are mounted rotatably relatively to one another about a common rotational axis D. Each of the coupling components 1, 2, which are mounted rotatably relative to one another about the rotational axis D, have an accommodating body 11, 22, in which recesses 11A, 22A, constructed as hollow channels, accommodate two optical waveguides L1, L2 and L3, L4. The individual optical waveguides L1, L2, L3, L4 terminate longitudinally at the apertures A1, A2, A3, A4 directly or with the interposition of an additional imaging unit O1, O2, as is illustrated as an optional embodiment in the accommodating body 11. The apertures have exposed openings within the coupling components 1, 2, via which light can enter into or emerge from the respective optical waveguide L1, L2, L3, L4 along the optical transmission channels K1, K2. The apertures A1, A2 provided on the first coupling component 1 are orientated in such a manner to be orientated along the rotational axis D facing the apertures A3, A4 added on the second coupling component 2. The respectively first apertures A1, A3 of the first and second coupling components 1, 2 are each located centrally relative to the rotational axis D within the coupling components 1, 2 assigned to the same. The second apertures A2, A4 are arranged radially spaced from the rotational axis D. Not necessarily, but advantageously, the second aperture A2 of the first coupling component 1 is arranged with a radial spacing from the rotational axis D, which differs from the radial spacing of the second aperture A4 of the second coupling component 2 which is spaced from the rotational axis D. The different radial spacing is expressed in particular in the spatially separated ray guidance or light paths along the two optical transmission channels K1, K2, which is in each case between the apertures A1, A2 or A3, A4. Thus, the light path passing through the first aperture A1 of the first coupling component 1, which corresponds to the first optical transmission channel K1, enters into the second aperture A4 of the second coupling component 2, as the result of a suitable ray deflection, which is described in more detail below. In contrast, the second optical transmission channel K2, which passes through the second aperture A2 of the first coupling component, is imaged into the first aperture A3 of the second coupling component 2 by suitable deflection. An essentially separated ray guidance of both optical transmission channels K1 and K2 between the apertures within the optical rotary coupling is enabled, on account of the different radial spacing of the respective second apertures A2, A4 from the rotational axis D.

In addition to the already-mentioned accommodating body 11 for the fixing of the optical waveguides L1, L2, the first coupling component 1 comprises a first sleeve section 111, which is integral with the accommodating body 11 or is securely joined in a separable manner to the same, particularly in a rotationally fixed manner with respect to the rotational axis D. The essentially rotationally symmetrically constructed first sleeve section 111 comprises and inner cavity, which is closed on one side by the accommodating body 11. The end of the sleeve section 111 faces away from the accommodating body 11 longitudinally relative to the rotational axis which is constructed as a sleeve end 112 which open. Furthermore, the first sleeve section 111 has a tooth structure 113, which engages a ring gear 5, running all the way round in the circumferential direction to be radially externally in the region of the first sleeve end 112 of open construction. The ring gear 5 is a hollow cylinder 51 having a cylinder axis arranged to be offset in a co-parallel manner to the rotational axis D. Furthermore, two axially spaced gear tooth structures 52 and 53 are internally circumferentially applied on the inside of a mantle of the hollow cylinder 51. One of the two gear tooth structures 52 enters into engagement with the tooth structure 113 of the first sleeve section 111. In the illustration according to FIG. 1a, the tooth structure 113 of the illustrated lower half of the first sleeve section 111 is in engagement with the gear tooth structure 52 of the ring gear 51.

The gear unit 5 is used for transmitting the rotational movement of the first coupling component 1, comprising the accommodating body 11 and the sleeve section 111, to a second sleeve section 114 mounted to be spaced along the rotational axis D from the first sleeve section 111. The second sleeve section 114 is likewise rotationally symmetrically constructed and comprises a cylindrical cavity, which is open at two sides longitudinally relative to the rotational axis D. The second sleeve section 114 has a toothing structure 116 on the outer circumference thereof in the region of the sleeve end 115 facing the first sleeve section 111, which toothing structure enters into engagement with the gear toothing 53 located internally on the hollow cylinder 51 of the ring gear 5, along a lower circumferential segment region thereof shown in the illustration.

The components are rotatably connected to one another via the ring gear 5, that is the accommodating body 11. The first sleeve section 111 is connected to the same in a rotationally fixed manner, and also the second sleeve section 114 and as a whole constitute components of the first coupling component 1 and are rotatably mounted with respect to the second coupling component 2 via pivot bearings 61, 62, 63.

The second coupling component likewise has an accommodating body 22, in which recesses 22A accommodate two optical waveguides L3 and L4 which are introduced, so that the apertures A3, A4 assigned to the optical waveguides L3, L4 are orientated on internal walls of the rotary coupling facing the first coupling component 1. A third sleeve section 222 is securely connected to the accommodating body 22, which includes a substantially rotationally symmetrical sleeve section 2220, which radially surrounds an inner cavity, into which the second sleeve section 114, of the first coupling component 1 axially protrudes at least to some extent and is supported on the sleeve section 2220 via the pivot bearing 63.

Furthermore, the third sleeve section 222 has a sleeve collar 2221, which is not constructed to be rotationally symmetrically and which integrally joins the rotationally symmetrical sleeve section 2220 axially to the rotational axis D and axially protrudes beyond the internally arranged second sleeve section 114 in the direction of the first coupling component 1. The sleeve collar 2221 penetrates a radial gap between the radially outer gear toothing 53 of the ring gear 5 and the toothing 116 of the second sleeve section 114. The end of the sleeve collar 2221 axially facing the first coupling component 1 is connected to the first optical deflector unit 3, which includes the following components: A retaining sleeve element 30, two transparent support elements 31, 32, preferably in the form of transparent, thin-walled glass panes, and also two optical reflectors R1, R2, preferably in the form of highly reflective coatings, preferably metal coatings, particularly preferably gold coatings, to which the optical reflector R1 is attached centrically to the rotational axis D and the optical reflector R2 is arranged on the support element 32 with a spacing from the rotational axis D, which corresponds to the radial spacing of the second aperture A4 of the second coupling component 2. The support elements 31, 32 are plates which are rigidly connected on the sleeve or hollow cylindrical retaining element 30 and attached parallel to one another to be inclined with respect to the rotational axis D, so that the first optical transmission channel K1 is imaged by double reflection from the first aperture A1 of the first coupling component 1 to the second aperture A4 of the second coupling component 2 or vice versa. Although the first deflector unit 3 is connected in a rotationally fixed manner to the second coupling component 2 and thus is rotatably mounted relatively to the first sleeve section 111, the reflection at the first optical reflector R1 is rotationally not variable. By contrast, the reflection at the second optical reflector R2 is spatially fixed to the location of the first optical reflector R1 and the second aperture A4 of the second coupling component 2. Owing to the transparent construction of both support elements 31, 32 and also the location of the second optical reflector R2, it is possible that the second optical transmission channel K2 losslessly penetrates both transparent support elements 31, 32, preferably in a radial area, which lies radially outside the attachment of the second optical reflector R2.

The second optical deflector unit 4, which rotates with the first coupling component 1 and is connected securely to the second sleeve section 114, takes care of the optical deflection of the second optical transmission channel K2. The second optical deflector unit 4 has a sleeve retaining element 40, on which two transparently constructed support elements 41, 42 are attached in an axially spaced manner. The support elements preferably are transparent thin-walled glass panes, as in the case of the first optical deflector unit 3. Both support elements 41, 42 are rigidly connected to one another via the retaining element 40, which is in turn joined to the second sleeve section 114 of sleeve-like construction in a rotationally fixed manner.

For deflecting the second optical transmission channel K2, an optical reflector R4 is attached on the support element 42 in a locally region with radial spacing from the rotational axis D, which is identical to the radial spacing of the second aperture A2 of the first coupling component 1. In this manner, it is possible to arrange the ray path, which can be assigned to the second optical transmission channel K2 to losslessly penetrates the transparent support elements 31, 32 and also 41, substantially parallel to the rotational axis D. At the location of the optical reflector R4, the second optical transmission channel K2 is deflected for further reflection onto the optical reflector R3 attached centrally to the rotational axis D, which directs the second optical transmission channel K2 through the first aperture A3 of the second coupling component 2.

In a preferred manner, the ring gear 5 is constructed so that the second sleeve section 114 and also the second optical deflector unit 4 rigidly connected to the ring gear rotates about the rotational axis D in a rotationally fixed manner with the first section 111 of the first sleeve coupling component 1. In the event of a ratio deviating from a 1:1 gear ratio, it is necessary to construct the optical reflector R4 on the transparent support element 42 in the form of an annular disc, by means of which an interruption-free ray deflection of the second optical transmission channel K2 is always ensured independently of the rotation state of both coupling components 1, 2.

For the further radial support of the pivot bearing 61, a housing 2222 encompassing the rotary coupling is provided, which is securely connected in a rotationally fixed manner both to the third sleeve section 222 and also the accommodating body 22 of the second coupling component 2. The pivot bearing 62 is likewise supported on the housing 2222 for rotatable mounting and radial encompassing of the ring gear 5. Thus, the second coupling component 2 comprises the following components: the accommodating body 22, the sleeve section 2220 with the first optical deflector unit 3 securely attached thereon and also the housing 2222.

Illustrated in FIG. 1b is an alternative exemplary embodiment for an optical rotary coupling. Components acting in the same manner, which have already been explained above for the optical rotary coupling shown in the FIG. 1a, are provided with previously explained reference numbers. By contrast with the rotary coupling illustrated in FIG. 1a, what is known as a spur gear 5′, is provided for rotary transmission of the rotational movement of the first coupling component 1, comprising the accommodating body 11 and also the first sleeve section 111, to the second sleeve section 114, the gear structures 52′, 53′ which engage oppositely contoured tooth structures 113, 116, which are provided in local regions of the outer circumference of the first sleeve section 111 and also the second sleeve section 114 on the other hand. The spur gear 5′ is located as a solitary gear unit lateral to the rotational axis D in a housing wall part 2222, which is connected as a component of one or more parts to the second coupling component 2 or is part of the second coupling unit.

The second coupling component 2 comprises an accommodating body 22, which like the exemplary embodiment in FIG. 1a has recesses 22A for accommodating the optical waveguides L3 and L4, a third sleeve section 222, which radially surrounds an inner cavity, into which the second sleeve section 114 protrudes, which is held rotatably about the rotational axis D by the engagement of the tooth structure 116 into the spur gear tooth structure 53′. Furthermore, the second sleeve section 114 is at the same time also is used as a retaining element for the second optical deflector unit 4, which is composed of the support elements 41, 42, on which the optical reflectors R3, R4 are securely attached. In contrast to the exemplary embodiment according to FIG. 1a, the second optical deflector unit 4 only provides a transparent support element 41, which is penetrated by the ray paths along the first and second optical transmission channels K1, K2. The respective other support element 42 is located completely radially spaced from the rotational axis D outside of the ray paths of both optical transmission channels and provides a highly reflective layer as optical reflector R4. For deflecting the second optical transmission channel K2, the light path passing through the second aperture A2 of the first coupling component 1, which runs parallel to and spaced from the rotational axis D, is deflected at the optical reflector R4 attached radially spaced from the rotational axis D to the optical reflector R3 arranged centrally with respect to the rotational axis. The light path deflected therefrom is still co-parallel to the rotational axis D into the first aperture A3 of the second coupling component 2. As the second optical deflector unit 4 rotates relative to the first aperture A3 of the second coupling component 2, the deflection of the second optical transmission channel K2 at the optical reflector R3 attached centrally to the rotational axis D is not variable in rotation. In contrast, with respect to the reflection event at the location of the optical reflector R4, it is ensured by the spur gear 5′ that the second aperture A2 of the first coupling component 1 rotates synchronously with the azimuthal position of the optical reflector R4 on the second sleeve section 114.

The first optical deflector unit 3 is connected to the second coupling component 2 in a rotationally fixed manner. A sleeve shaped section 2223 is connected in one or multiple parts to the third sleeve section 222 in a detachable secured manner and is used as a rotationally fixed support structure for the retaining element 30 of the first optical deflector unit 3, on which the transparent support element 31 with the optical reflector R1 is attached centrally with respect to the rotational axis and also the second optical reflector R2 is attached. In contrast with the embodiment according to FIG. 1a, the optical reflector R2, which is arranged radially spaced from the rotational axis D, is not attached on a transparent support element, which is at the same time penetrated by at least one of the two optical transmission channels K1, K2. Rather, in this case, the optical reflector R2 is attached indirectly or directly on the retaining element 30 itself in a region radially spaced from the rotational axis, which clearly lies outside of the ray paths of both optical transmission channels K1, K2.

The optical rotary coupling illustrated in FIG. 1b therefore has two transparent support elements 31, 41, which preferably are glass panes, which are penetrated by both optical transmission channels K1, K2. Both radially to the rotational axis D directly on the retaining element 30 or to the second sleeve section 114, reflectors R2 and R4 are arranged radially to the rotational axis D in such a manner to not be tangent to the optical transmission channels K2 respectively K1.

In order to dimension the overall diameter of the optical rotary coupling to be as small as possible, the second aperture A4 of the second coupling component 2 is arranged to be inclined with respect to the rotational axis D, so that the light path running between the optical reflector R2 of the first optical deflector unit 3 and the second aperture A4 of the second coupling component does not run parallel to the rotational axis, but instead rather runs cutting the optical axis.

Like in the exemplary embodiment according to FIG. 1a, the first coupling component 1 is also radially encompassed by the pivot bearing 61, which is supported radially outwardly on the housing wall 2222, which substantially cylindrically encompasses the optical rotary coupling and which is connected in one part or in multiple parts to the second coupling component 2.

In FIG. 1c, a high schematized alternative illustration for implementing the first and second optical deflector units is shown instead of the optical deflector units 3, 4 illustrated in FIG. 1a. Thus, like the illustration illustrated in FIG. 1a, the second optical deflector unit 4 has a retaining sleeve element 40, which by contrast to what is shown in FIG. 1a, only comprises a single transparent support element 41. A first deflecting prism P1 and radially spaced from P1, and a second deflecting prism P2 are attached on support element 41 preferably constructed as a transparent glass plate centrally located relative to the rotational axis D. Both deflecting prisms P1, P2 can be arranged locally on the same side of the support element 41 constructed as a glass plate. The first optical deflector unit 3 is similarly structured, on the retaining sleeve to which element 30, of a single support element 31 constructed as a transparent glass plate is attached, on which two prisms P3, P4 are likewise attached. In view of the lower radial spacing of the prism P4 from the rotational axis D, it is possible to integrate both prism faces P3, P4 in a single prism body. As is concluded from the light path of both optical transmission channels K1, K2, the prism pair P3, P4 therefore is able, like the exemplary embodiment according to FIG. 1a, to image the first optical transmission channel K1 from the first aperture A1 of the first coupling component 1 into the second aperture A4 of the second coupling component 2. Accordingly, the prism faces P1, P2 are able to image the second aperture A2 of the first coupling component 1 onto the first aperture A3 of the second coupling component 2, which is arranged centrally with respect to the rotational axis D.

In all illustrated exemplary embodiments, the optical transmission channels can be used bidirectionally, that is the optical rotary coupling does not have a predetermined direction of optical transmission.

Owing to the purely mechanical solution for rotation transmission, the novel optical rotary coupling is substantially more robust and less susceptible to faults with respect to external disturbances that may occur, such as vibrations, external magnetic fields, etc. Added to this is the fact that due to the mechanically rigid mounting of the optical reflectors each deflecting one transmission channel attenuation losses are minimized and imaging errors can be excluded because of reflector orientations that can be undertaken precisely. The installation of the optical rotary coupling constructed according to the invention can also be carried out precisely and cost effectively due to corresponding prefabrication and pre-adjustments.

### REFERENCE LIST

1 First coupling component
11 Accommodating body
11A Recesses
111 First section of sleeve-like construction
112 Open sleeve end
113 Toothing structure
114 Second section of sleeve-like construction
115 Open sleeve end
116 Toothing structure
2 Second coupling component
22 Accommodating body
22A Recesses
222 Third section of sleeve-like construction
2220 Sleeve section
2221 Sleeve collar
2222 Housing
2223 Sleeve-like shaped section
3 First optical deflector unit
30 Sleeve-like retaining element
31, 32 Transparent support element
4 Second optical deflector unit
40 Sleeve-like retaining element
41, 42 Transparent support element
R1, R2, R3, R4 Optical reflectors
5 Gear, ring gear
51 Hollow cylinder
52, 53 Gear toothing
5′ Spur gear
52′, 53′ Spur gear toothing
61, 62, 63 Pivot bearing
A1 First aperture of the first coupling component
A2 Second aperture of the first coupling component
A3 First aperture of the second coupling component
A4 Second aperture of the second coupling component
L1, L2, L3, L4 Optical waveguide
D Rotational axis
K1 First optical transmission channel
K2 Second optical transmission channel
01, 02 Optical imaging unit
P1-P4 Deflecting prism

1-14. (canceled)

15. A rotary coupling for transmitting optical signals along at least two separate optical transmission channels, comprising a first and a second coupling component that are mounted rotatably relative to one another about a common rotational axis and which have at least two recesses each for accommodating two optical waveguides, which end within a coupling component and include apertures to which the optical signals can be coupled directly or indirectly in or out, wherein in each coupling component a first aperture is located centrally to the rotational axis and a second aperture is located radially spaced from the rotational axis;
at least one first and second optical deflector unit with the first optical deflector unit deflecting the first optical transmission channel running through the first aperture of the first coupling component and also through the second aperture of the second coupling component and the second optical deflector unit deflecting the second optical transmission channel running through the second aperture of the first coupling component and also through the first aperture of the second coupling component;
the first optical deflector unit having the second coupling component and the second optical deflector unit having the first coupling component are rotatable about the rotational axis, wherein the first optical deflector unit is disposed along the rotational axis between the second optical deflector unit and the first coupling component and is rotatably coupled to the first optical deflector unit; and wherein
the optical deflector units each comprise first and second optical reflectors which each are rigidly connected to one another indirectly or directly via a retaining element; and
the retaining element of the second optical deflector unit is indirectly or directly in engagement with the first coupling component via a mechanical gear unit.

16. The rotary coupling according to claim 15, wherein:
the retaining element of the first optical deflector unit is indirectly or directly connected in a rotationally fixed and mechanically rigid manner to the second coupling component.

17. The rotary coupling according to claim 15, wherein:
the mechanical gear unit is a spur or ring gear.

18. The rotary coupling according to claim 15, wherein:
the mechanical gear unit is a spur or ring gear.

19. The rotary coupling according to claim 14, wherein:
the retaining elements each comprise longitudinal hollow bodies including a hollow channel passing through the hollow body in a longitudinal direction of the hollow body, and
the rotational axis extends longitudinally and centrally in the hollow channel of the hollow body.

20. The rotary coupling according to claim 15, wherein:
the retaining elements each comprise longitudinal hollow bodies including a hollow channel passing through the hollow body in a longitudinal direction of the hollow body, and
the rotational axis extends longitudinally and centrally in the hollow channel of the hollow body.

21. The rotary coupling according to claim 16, wherein:
the retaining elements each comprise longitudinal hollow bodies including a hollow channel passing through the hollow body in a longitudinal direction of the hollow body, and
the rotational axis extends longitudinally and centrally in the hollow channel of the hollow body.

22. The rotary coupling according to claim 17, wherein:
the retaining elements each comprise longitudinal hollow bodies including a hollow channel passing through the hollow body in a longitudinal direction of the hollow body, and
the rotational axis extends longitudinally and centrally in the hollow channel of the hollow body.

23. The rotary coupling according to claim 18, wherein:
the retaining elements each comprise longitudinal hollow bodies including a hollow channel passing through the hollow body in a longitudinal direction of the hollow body, and
the rotational axis extends longitudinally and centrally in the hollow channel of the hollow body.

24. The rotary coupling according to claim 14, wherein:
the first and second optical deflector units include at least one support element, which is transparent for at least one optical transmission channel and on which the at least two optical reflectors are attached for deflecting a transmission channel;
one of the at least two reflectors is attached centrally with respect to the rotational axis; and
another of the at least two reflectors is attached radially spaced from the rotational axis and slips over an annular surface during rotation of the annular surface about the rotational axis and the annular surface does not intersect the other optical transmission channel that extends into the transparent support element.

25. The rotary coupling according to claim 15, wherein:
the first and second optical deflector units include at least one support element, which is transparent for at least one optical transmission channel and on which the at least two optical reflectors are attached for deflecting a transmission channel;
one of the at least two reflectors is attached centrally with respect to the rotational axis; and
another of the at least two reflectors is attached radially spaced from the rotational axis and slips over an annular surface during rotation of the annular surface about the rotational axis and the annular surface does not intersect the other optical transmission channel that extends into the transparent support element.

26. The rotary coupling according to claim 16, wherein:
the first and second optical deflector units include at least one support element, which is transparent for at least one optical transmission channel and on which the at least two optical reflectors are attached for deflecting a transmission channel;
one of the at least two reflectors is attached centrally with respect to the rotational axis; and
another of the at least two reflectors is attached radially spaced from the rotational axis and slips over an annular surface during rotation of the annular surface about the rotational axis and the annular surface does not intersect the other optical transmission channel that extends into the transparent support element.

27. The rotary coupling according to claim 17, wherein:
the first and second optical deflector units include at least one support element, which is transparent for at least one optical transmission channel and on which the at least two optical reflectors are attached for deflecting a transmission channel;
one of the at least two reflectors is attached centrally with respect to the rotational axis; and
another of the at least two reflectors is attached radially spaced from the rotational axis and slips over an annular surface during rotation of the annular surface about the rotational axis and the annular surface does not intersect the other optical transmission channel that extends into the transparent support element.

28. The rotary coupling according to claim 18, wherein:
the first and second optical deflector units include at least one support element, which is transparent for at least one optical transmission channel and on which the at least two optical reflectors are attached for deflecting a transmission channel;
one of the at least two reflectors is attached centrally with respect to the rotational axis; and
another of the at least two reflectors is attached radially spaced from the rotational axis and slips over an annular surface during rotation of the annular surface about the rotational axis and the annular surface does not intersect the other optical transmission channel that extends into the transparent support element.

29. The rotary coupling according to claim 19, wherein:
the first and second optical deflector units include at least one support element, which is transparent for at least one optical transmission channel and on which the at least two optical reflectors are attached for deflecting a transmission channel;
one of the at least two reflectors is attached centrally with respect to the rotational axis; and
another of the at least two reflectors is attached radially spaced from the rotational axis and slips over an annular surface during rotation of the annular surface about the rotational axis and the annular surface does not intersect the other optical transmission channel that extends into the transparent support element.

30. The rotary coupling according to claim 20, wherein:
the first and second optical deflector units include at least one support element, which is transparent for at least one optical transmission channel and on which the at least two optical reflectors are attached for deflecting a transmission channel;
one of the at least two reflectors is attached centrally with respect to the rotational axis; and
another of the at least two reflectors is attached radially spaced from the rotational axis and slips over an annular surface during rotation of the annular surface about the rotational axis and the annular surface does not intersect the other optical transmission channel that extends into the transparent support element.

31. The rotary coupling according to claim 21, wherein:
the first and second optical deflector units include at least one support element, which is transparent for at least one optical transmission channel and on which the at least two optical reflectors are attached for deflecting a transmission channel;
one of the at least two reflectors is attached centrally with respect to the rotational axis; and
another of the at least two reflectors is attached radially spaced from the rotational axis and slips over an annular surface during rotation of the annular surface about the rotational axis and the annular surface does not intersect the other optical transmission channel that extends into the transparent support element.

32. The rotary coupling according to claim 22, wherein:
the first and second optical deflector units include at least one support element, which is transparent for at least one optical transmission channel and on which the at least two optical reflectors are attached for deflecting a transmission channel;
one of the at least two reflectors is attached centrally with respect to the rotational axis; and
another of the at least two reflectors is attached radially spaced from the rotational axis and slips over an annular surface during rotation of the annular surface about the rotational axis and the annular surface does not intersect the other optical transmission channel that extends into the transparent support element.

33. The rotary coupling according to claim 23, wherein:
the first and second optical deflector units include at least one support element, which is transparent for at least one optical transmission channel and on which the at least two optical reflectors are attached for deflecting a transmission channel;
one of the at least two reflectors is attached centrally with respect to the rotational axis; and
another of the at least two reflectors is attached radially spaced from the rotational axis and slips over an annular surface during rotation of the annular surface about the rotational axis and the annular surface does not intersect the other optical transmission channel that extends into the transparent support element.

34. The rotary coupling according to claim 24, wherein:
the reflectors comprise faces of at least one prism and each prism is joined to a surface of the support element.

35. The rotary coupling according to claim 15, wherein:
the reflectors comprise faces of at least one prism and each prism is joined to a surface of the support element.

36. The rotary coupling according to claim 16, wherein:
the reflectors comprise faces of at least one prism and each prism is joined to a surface of the support element.

37. The rotary coupling according to claim 17, wherein:
the reflectors comprise faces of at least one prism and each prism is joined to a surface of the support element.

38. The rotary coupling according to claim 18, wherein:
the reflectors comprise faces of at least one prism and each prism is joined to a surface of the support element.

39. The rotary coupling according to claim 14, wherein:
the first and second optical deflector units each include at least two support elements, which are transparent for at least one optical transmission channel and are fastened longitudinally to the rotational axis and spaced from one another on the retaining element;
at least one of the at least two support elements and one of the two reflectors is attached centrally relative to the rotational axis; and
another of the at least two support elements and another of the two reflectors is attached radially spaced from the rotational axis, and the reflector attached radially spaced from the rotational axis slips over an annular surface during rotation of the annular surface about the rotational axis and does not intersect the other optical transmission channel that penetrates into both transparent support elements.

40. The rotary coupling according to claim 35, wherein:
the reflectors attached separately on the support elements each comprise a reflective local coating.

41. The rotary coupling according to claim 14, wherein:
the first and second optical deflector units each include one support element, which is transparent for at least one optical transmission channel and which has the reflector located centrally relative to the rotational axis; and
another reflector is attached on the retaining element directly or indirectly with a radial spacing from the rotational axis, which is larger than a radial spacing from the rotational axis of the second aperture on the first and second coupling components.

42. The rotary coupling according to claim 24, wherein:
the at least one support element is a plane-parallel transparent glass plate element.

43. The rotary coupling according to claim 19, comprising:
a planar surface supporting the at least one optical reflector of at least one support element and the at least one support element is connected to the retaining element with a surface of the support element intersecting the longitudinal direction of the hollow channel at an angle α=90°±45° which at least partially penetrates a cross-section of the hollow channel.

44. The rotary coupling according to claim 14, wherein:
the first coupling component includes a body surrounded by at least two recesses of the at least two optical waveguides;
the first coupling component includes a first plane section which indirectly or directly adjoins the body and extends along the rotational axis; and wherein
the first sleeve section includes an open end which radially encompasses a cavity, into which the retaining element supporting the first optical deflector unit protrudes through the open end; and
the retaining element indirectly or directly is connected in a rotationally fixed manner via a sleeve section connected to the second coupling component which has a second sleeve with an open end surrounding a cavity, into which the retaining element supporting the second optical deflector unit protrudes through the open second sleeve end; and
the mechanical gear unit engages an end of the first sleeve also indirectly or directly engages the retaining element of the second optical deflector unit.

45. The rotary coupling according to claim 44, wherein:
the mechanical gear unit is disposed radially from both the first sleeve section and to the first retaining element.

46. The rotary coupling according to claim 14, wherein:
the first and second coupling components include recesses which receive at least one first and second optical waveguide, the first aperture is located at one end of the first optical waveguide and an end of the second optical waveguide is located at the second aperture or the ends of the optical waveguides are imaged indirectly into the first and second apertures each via at least one optical unit.
